(19) United States
(12) Patent Application Publication
(10) Pub. No.: US 2022/0186914 A1
(43) Pub. Date: Jun. 16, 2022

(54) THREE-SECTION HINGEDLY CONNECTED LIGHTING PANEL

(71) Applicant: Gradus Group LLC, New York, NY (US)

(72) Inventor: Jacob Frankl, New York, NY (US)

(21) Appl. No.: 17/550,821

(22) Filed: Dec. 14, 2021

Related U.S. Application Data
(60) Provisional application No. 63/125,327, filed on Dec. 14, 2020.

(51) Int. Cl. F21V 17/10; F21V 21/06; F21V 21/30; F21V 29/76

(52) U.S. Cl. CPC F21V 17/107; F21V 21/06; F21Y 2115/10; F21V 29/76; F21V 21/30

(57) ABSTRACT

A three-section, hingedly connected lighting panel assembly includes a center light panel, a right light panel and a left light panel. The right and left light panels being hingedly connected to the center light panel and foldable over it in a stowed condition of the assembly. Each panel is in its own respective housing that has a rear side and front side. Each of the light panels is provided with a respective plurality of LED lights whose light is aimed in the front direction of each of the panel housings. The hinges connecting the panels to each other are configured to allow the left and right panels to lie in a same flat plane associated with said center panel and to be selectively folded over the center light panel, to facilitate storing and carrying the assembly.

### CROSS-REFERENCE TO RELATED APPLICATION

The present non-provisional patent application claims the benefit of and priority to U.S. Provisional Patent Application No. 63/125,327, filed Dec. 14, 2020, by Jacob Frankl, and entitled “THREE-SECTION, HINGEDLY CONNECTED LIGHTING PANEL,” the entire contents of which are incorporated herein by reference.

### BACKGROUND OF THE INVENTION

The present invention is generally directed to lighting panels and, more particularly, to lighting panels that find greater applicability in photographic settings. The present Applicant refers to this lighting panel by its currently intended brand name “LED Mark II.”

The LED Mark II is a light using LEDs to project light. It has LEDs distributed on a central panel and on two smaller folding outside panels. These panels may be permanently hinged to each other. In another embodiment, they may be daisy-chained. The panels may share a common power supply or be individually powered. The light is diffused by optionally removable filters in front of the LEDs that soften the appearance and increase the spread of the light. The Central panel is the key light and emits a fixed value of light and hosts the mounting hardware and power connection. The folding light panels are connected to the central panel with hinges and wires that distribute power. The ability to fold the panels are what makes the light unique and which provides four primary purposes.

First, when the panels are opened flat the light is similar to any flat panel light. Second, the foldable panels allow the available light to be modified by folding the outside panels and thereby modifying the beam angle. Third, they fold to make the light more compact and easily transported. Fourth, the folding panels fold to protect the front face of the light during transport.

The design of the panel is meant to give the user a flat panel flood light with a broad beam angle while replacing conventional barn doors with movable light panels that not only block or modify the light but also project light and create a unique appearance to the light projected.

### SUMMARY OF THE INVENTION

Accordingly, it is an object of the present invention to provide a foldable light panel which has at least the features summarized above and which can be provided at a reasonable price.

The foregoing and other objects of the invention are realized in accordance with certain preferred embodiments by the panels that are depicted and described below, comprising a main center light panel flanked by foldable left and right light panels, as more fully described below.

In accordance with preferred embodiments, the three-section, hingedly connected lighting panel assembly includes a center light panel, a right light panel and a left light panel, with the right and left light panels being hingedly connected to said center light panel, each at a respective hinge thereof. Each light panel has a respective housing thereof wherein the housing has rear side and front side; each of the light panels being provided with a respective plurality of LED lights being installed in each of the panels, the LED light being mounted to direct light in the front direction of each of the panel housings, each housing including electronics for driving the LED light to selectively emit the light, and wherein. The hinges are configured to allow the left and right panels to lie in a same flat plane with the center panel and to be selectively folded over the center light panel.

Preferably, the three-section, hingedly connected lighting includes a respective filter mountable over the plurality of LED lights of each the panels, which can be slidable. It also includes mounting hardware configured to enable connecting the lighting panel assembly to a tripod or other photographic support.

The lighting panel assembly includes an electrical interface that is configured to provide to the panels one or more of electrical power and control signals and a tightening knob that is configured to maintain the orientations of the left and right panels to the center panel at desired angular directions. Dissipating fins are provided for each of the panel to dissipate heat developing therein.

Also preferably, the lighting panel assembly produces daylight light at a color temperature of about 5600 degrees Kelvin and the left and right panels have respective width and length dimensions in the ranges of 60-70 mm and 165-175 mm. In the folded condition of the left and right panels, the heat dissipating fins extend over most of the outer surface of the lighting panel assembly, most preferably entirely.

Other features and advantages of the present invention will become apparent from the following description of the invention which refers to the accompanying drawings.

### BRIEF DESCRIPTION OF THE DRAWINGS

FIG. 1 shows the light panel of the present invention with the side panels partially folded.

FIG. 2 shows the light panel of the present invention unfolded, depicting its rear side.

FIG. 3 shows the light panel unfolded with the front view depicted.

FIG. 4 shows the light panel of FIG. 3 with the individual removable filters partially withdrawn.

FIG. 5 shows the light panel with the individual filters totally removed.

FIG. 6 shows a bottom view, partially folded.

FIG. 7 shows a front view with one panel folded over and one panel partially unfolded.

FIG. 8 shows the light panel with both panels folded.

### DETAILED DESCRIPTION OF PREFERRED EMBODIMENTS OF THE INVENTION

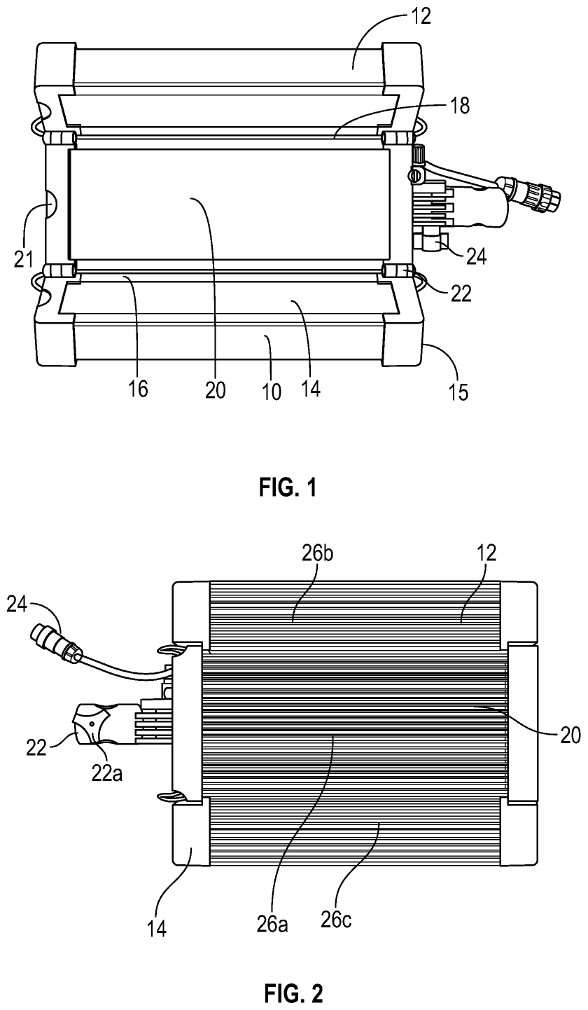

Referring to FIG. 1, the light panel 10 is shown to be flanked by a right side light panel 12 and a left side light panel 16 with a first hinge 16 and a second hinge 18 that allow the light panels 12 and 14 to be folded onto the center panel 20. The center panel has its interior components and certain LEDs housed in a housing 21, with the corresponding housings 13 and 15 for the side panels, respectively. Mounting hardware 22 allows the panel to be connected to a tripod or other mounting structures. Electrical connections can be provided through the connector 24.

FIG. 2 shows the unfolded light panel from the rear view thereof showing that each of the panels at the rear comprises respective heat dissipating fins 26a, 26b and 26c, respectively for the panels 20, 12 and 14. The electrical connector 24 is located on a bottom side of the center panel 20 and the mounting hardware 22 has a tightening knob 22a that presses a bar against a surface of the panels to maintain a desired orientation thereof.

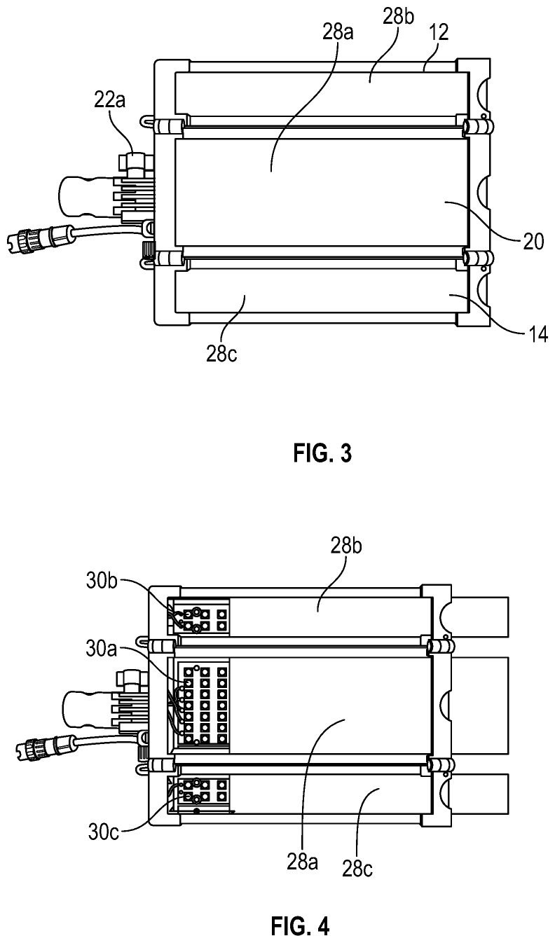

FIG. 3 shows the three-part light panel 10 from the front side thereof with the light emitting side covered by respective, filters 28a, 28b and 28c that may be removable at will in accordance with an embodiment of the invention.

As shown in FIG. 4, the filters 28a, 28b and 28c can be slid away by releasing a portion of the panel housing exposing underneath the light emitting diodes for the three LED panels, namely LED matrices 30a, 30b and 30c.

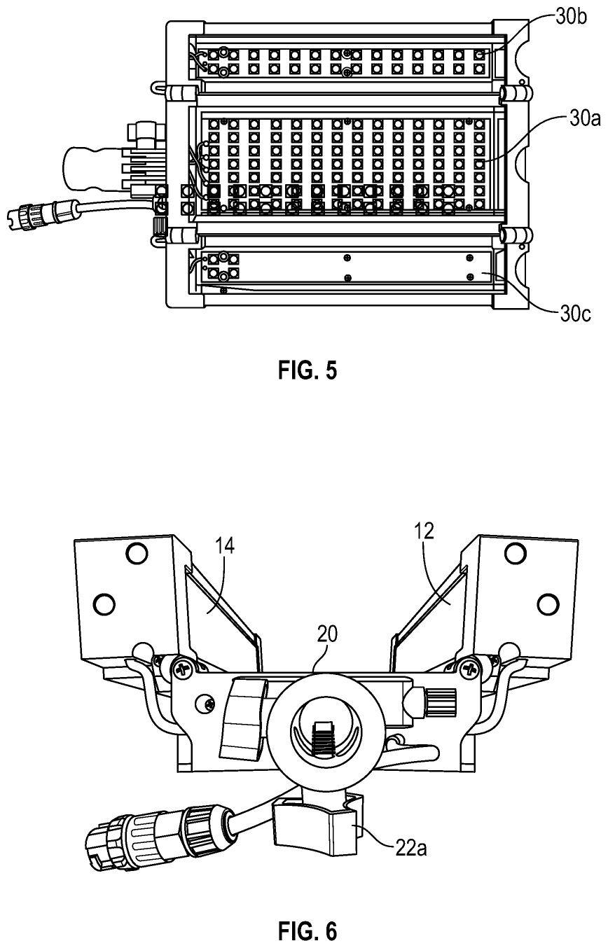

In FIG. 5, the entire array of LEDs can be seen owing to the total removal of the removable filters.

FIG. 6 shows an end view from the top showing the electrical connector and the attaching mechanism with the knob 22a and also the two panels 12 and 14 partially bend at an angle that meets the center panel 20 at an angle greater than 90° which will create a particular lighting pattern which can be changed by adjusting the positions of the side panels 12 and 14. In an embodiment, a tightening mechanism can be provided to assure that the position and holding power of the hinges can maintain the folded/angular orientations of the panels of the overall light panel 10 as desired.

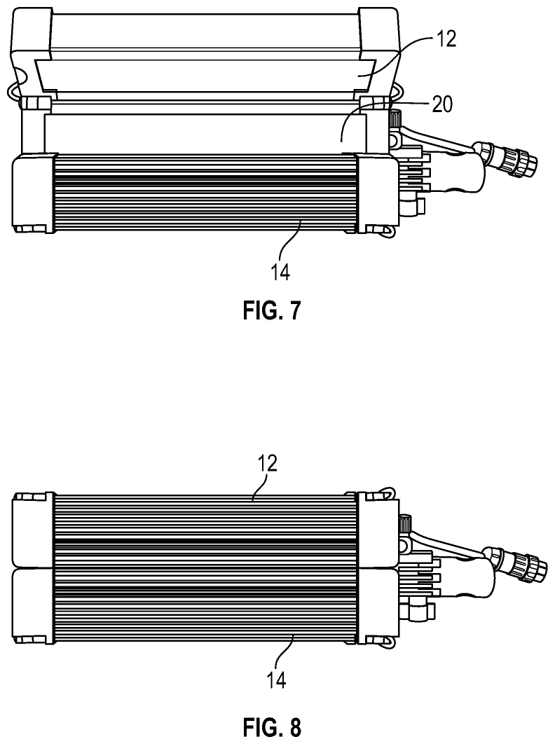

In FIG. 7, the center light panel 20 is partially covered over by the side light panel 14 while the side panel 12 is partially unfolded creating a desired lighting pattern.

In accordance with preferred embodiments, the light panels 12, 14 and 16 may have width and length dimensions of 60-70 mm and 165-175 mm, respectively. Alternatively, the center panel 10 may be larger than the side panel, preferably twice as large, so that the side panels are foldable over and configured to cover the center panel in the folded position.

As will be apparent to one skilled in the art, the panel can come with various electrical controls for controlling the light emanating from the LEDs and the LEDs can be provided so as to be selectably powered to provide light of a color temperature that can be set in accordance with a user's needs for the particular application, as described in the prior art. In one embodiment, the LEDs out light at a 5600K (daylight) temperature.

FIG. 8 shows the side panels 12, 14 folded over presenting a total package size that can be easily stowed and transported by photographers and other users of the light panel of the present invention.

Although the present invention has been described in relation to particular embodiments thereof, many other variations and modifications and other uses will become apparent to those skilled in the art. It is preferred, therefore, that the present invention be limited not by the specific disclosure herein, but only by the appended claim.

What is claimed is:

1. A three-section, hingedly connected lighting panel assembly, comprising:
a center light panel, a right light panel and a left light panel, said right and left light panels being hingedly connected to said center light panel, each at a respective hinge thereof, each of said light panels comprising a respective housing thereof wherein said housing has a rear side and a front side;
each of said light panels being provided with a respective plurality of LED lights being installed in each of said panels, said LED light being mounted to direct light in the front direction of each of said panel housings, each housing including electronics for driving said LED light to selectively emit said light, and wherein;
said hinges are configured to allow the left and right panels to lie in a same flat plane with said center panel and to be selectively folded over said center light panel.

2. The three-section, hingedly connected lighting panel assembly of claim 1, including a respective filter mountable over the plurality of LED lights of each said panels.

3. The three-section, hingedly connected lighting panel assembly of claim 2, wherein each of the filters is slidable over the LED lights associated therewith.

4. The three-section, hingedly connected lighting panel assembly of claim 1, including mounting hardware configured to enable connecting said lighting panel assembly to a tripod or other photographic support.

5. The three-section, hingedly connected lighting panel assembly of claim 4, wherein the mounting hardware is provided at the center panel.

6. The three-section, hingedly connected lighting panel assembly of claim 1, including an electrical interface that is configured to provide to the panels one or more of electrical power and control signals.

7. The three-section, hingedly connected lighting panel assembly of claim 1, including a tightening knob that is configured to maintain the orientations of the left and right panels to the center panel at desired angular directions.

8. The three-section, hingedly connected lighting panel assembly of claim 1, including heat dissipating fins respectively provided for each of the panel to dissipate heat developing therein.

9. The three-section, hingedly connected lighting panel assembly of claim 1, wherein the LED light are selected to produce daylight light at a color temperature of about 5600 degrees Kelvin.

10. The three-section, hingedly connected lighting panel assembly of claim 1, wherein the left and right panels have respective width and length dimensions in the ranges of 60-70 mm and 165-175 mm.

11. The three-section, hingedly connected lighting panel assembly of claim 1, wherein in the folded condition of the left and right panels, the heat dissipating fins extend over most of the outer surface of the lighting panel assembly.

12. The three-section, hingedly connected lighting panel assembly of claim 1, wherein in the folded condition of the left and right panels, the heat dissipating fins extend over substantially the entirety of the outer surface of the lighting panel assembly.
